(19) United States
(12) Patent Application Publication
(10) Pub. No.: US 2003/0065512 A1
(43) Pub. Date: Apr. 3, 2003

(54) Communication device and a method for transmitting and receiving of natural speech

(75) Inventor: Michael Walker, Baltmannsweiler (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/252,516

(22) Filed: Sep. 24, 2002

(30) Foreign Application Priority Data
Sep. 28, 2001 (EP) 01 440 317.4

(51) Int. Cl. G10L 13/00

(52) U.S. Cl. 704/258

(57) ABSTRACT

The invention relates to a communication device, such as a mobile phone, a personal digital assistant or a computer system, comprising a speech parameter detector 3 and a speech recognition module 4 coupled to an encoder 5. The set of speech parameters of a speech synthesis model determined by the speech parameter detector 3 as well as the encoded recognized natural speech provided by the encoder 5 is transmitted over a physical communication link. This has the advantage that only an extremely low data rate is required as the set of speech parameters is only transmitted once or at certain time intervals.

### BACKGROUND OF THE INVENTION

The invention is based on a priority application EP 01 440 31 7.4 which is hereby incorporated by reference.

The present invention relates to the field of communication devices and to transmitting and receiving natural speech, and more particularly to the field of transmission of natural speech with a reduced data rate.

### BACKGROUND AND PRIOR ART

In order to provide a maximum number of speech channels that can be transmitted through a band-limited medium, considerable efforts have been made to reduce the bit rate allocated to each channel. For example, by using a logarithmic quantization scale, such as in .mu.−Law PCM encoding, high quality speech can be encoded and transmitted at 64 kb/s. One variation of such an encoding method, adaptive .mu.−Law PCM (ADPCM) encoding, can reduce the required bit rate to 32 kb/s.

Further advances in speech coding have exploited characteristic properties of speech signals and of human auditory perception in order to reduce the quantity of data that needs to be transmitted in order to acceptably reproduce an input speech signal at a remote location for perception by a human listener. For example, a voiced speech signal such as a vowel sound is characterized by a highly regular short-term wave form (having a period of about 10 ms) which changes its shape relatively slowly. Such speech can be viewed as consisting of an excitation signal (i.e., the vibratory action of vocal chords) that is modified by a combination of time varying filters (i.e., the changing shape of the vocal tract and mouth of the speaker). Hence, coding schemes have been developed wherein an encoder transmits data identifying one of several predetermined excitation signals and one or more modifying filter coefficients, rather than a direct digital representation of the speech signal. At the receiving end, a decoder interprets the transmitted data in order to synthesize a speech signal for the remote listener. In general, such speech coding systems are referred to as a parametric coders, since the transmitted data represents a parametric description of the original speech signal.

Parametric speech coders can achieve bit rates of approximately 8-16 kb/s, which is a considerable improvement over PCM or ADPCM. In one class of speech coders, code-excited linear predictive (CELP) coders, the parameters describing the speech are established by an analysis-by-synthesis process. In essence, one or more excitation signals are selected from among a finite number of excitation signals; a synthetic speech signal is generated by combining the excitation signals; the synthetic speech is compared to the actual speech; and the selection of excitation signals is iteratively updated on the basis of the comparison to achieve a “best match” to the original speech on a continuous basis. Such coders are also known as stochastic coders or vector-excited speech coders.

U.S. Pat. No. 5,857,167 shows a parametric speech codec, such as a CELP, RELP, or VSELP codec, which is integrated with an echo canceler to provide the functions of parametric speech encoding, decoding, and echo cancellation in a single unit. The echo canceler includes a convolution processor or transversal filter that is connected to receive the synthesized parametric components, or codebook basis functions, of respective send and receive signals being decoded and encoded by respective decoding and encoding processors. The convolution processor produces and estimated echo signal for subtraction from the send signal.

U.S. Pat. No. 5,915,234 shows a method of CELP coding an input audio signal which begins with the step of classifying the input acoustic signal into a speech period and a noise period frame by frame. A new autocorrelation matrix is computed based on the combination of an autocorrelation matrix of a current noise period frame and an autocorrelation matrix of a previous noise period of frame. LPC analysis is performed with the new autocorrelation matrix. A synthesis filter coefficient is determined based on the result of the LPC analysis, quantized, and then sent. An optimal codebook vector is searched for based on the quantized synthetic filter coefficient.

A general overview of code excited linear prediction methods (CELP) and speech synthesis is given in Gerlach, Christian Georg: Beiträge zur Optimalität in der codierten Sprachübertragung, 1. Auflage Aachen: Verlag der Augustinus Buchhandlung, 1996 (Aachener Beiträge zu digitalen Nachrichtensystemen, Band 5), ISBN 3-86073-434-2.

### SUMMARY OF THE INVENTION

Accordingly it is one object of the invention to provide an improved communication device for transmitting and/or receiving natural speech as well as a corresponding computer program product and method featuring a low bit rate.

This and other objects of the invention are solved by applying the features laid down in the independent claims. Preferred embodiments of the invention are given in the dependent claims.

In accordance with one embodiment of the invention one or more speech parameters of a speech synthesis model are determined for natural speech to be transmitted. For this purpose any parametric speech synthesis model can be utilized, such as the CELP based speech synthesis model of the GSM standard or others. Preferably an analysis-by-synthesis approach is used to determine the speech parameters of the speech synthesis model.

Further the natural speech to be transmitted is recognized by means of a speach recognition method. For the purpose of speech recognition any known method can be utilized. Examples for such speech recognition methods are given in U.S. Pat. No. 5,956,681; U.S. Pat. No. 5,805,672; U.S. Pat. No. 5,749,072; U.S. Pat. No. 6,175,820 B1; U.S. Pat. No. 6,173,259 B1; U.S. Pat. No. 5,806,033; U.S. Pat. No. 4,682,368 and U.S. Pat. No. 5,724,410.

In accordance with a preferred embodiment of the invention the natural speech is recognized and converted into symbolic data such as text, characters and/or character strings. In accordance with a further preferred embodiment of the invention Huffman coding or other data compression techniques are utilized for coding the recognized natural speech into symbolic data words.

In accordance with a further preferred embodiment of the invention the speech parameters of the speech synthesis model which have been determined with respect to the natural speech to be transmitted as well as the data words containing the recognized natural speech in the form of symbolic information are transmitted from a communication device, such as a mobile phone, a personal digital assistant, a mobile computer or another mobile or stationary end user device.

In accordance with a preferred embodiment of the invention the set of speech parameters is only transmitted once during a communication session. For example, when a user establishes a communication link, such as a telephone call, the user's natural speech is analysed and the speech parameters being descriptive of the speaker's voice and/or speech characteristics are automatically determined in accordance with the speech synthesis model.

This set of speech parameters is transmitted over the telephone link to a receiving party together with the data words containing the recognized natural speech information. This way the required bit rate for the communication link can be drastically reduced. For example, if the user would read a text page with eighty characters per line and fifty rows, about 25.600 bits are needed.

Assuming this text page could be read by the user within two minutes, the required bit rate is 213 bit per seconds. The total bit rate can be selected in accordance with the required quality of the speech reproduction at the receiver side. If the set of speech parameters is only transmitted once during the entire conversation the entire bit rate, which is required for the transmission, is only slightly above 213 bit per second.

In accordance with a further preferred embodiment of the invention the set of speech parameters is not only determined once during a conversation but continuously, for example in certain time intervals. For example, if a speech synthesis model having 26 parameters is employed and the 26 parameters are updated each second during the conversation, the required total bit rate is less than 426 bit per second. In comparison to the bandwidth requirements of prior art communication devices for transmission of natural speech this is a dramatic reduction.

In accordance with a further preferred embodiment of the invention the communication device at the receiver's side comprises a speech synthesizer incorporating the speech synthesis model which is the basis for determining the speech parameters at the sender's side. When the set of speech parameters and the data words containing the information being descriptive of the recognized natural speech are received, the natural speech is rendered by the speech synthesizer.

It is a particular advantage of the present invention that the natural speech can be rendered at the receiver's side with a very good quality which is only dependent on the speech synthesizer. The rendered natural speech signal is an approximation of the user's natural speech. This approximation is improved if the speech parameters are updated from times to times during the conversation. However many speech parameters, such as loudness, frequency response, . . . , etc. are nearly constant during the whole conversation and therefore need only to be updated infrequently.

In accordance with a further preferred embodiment of the invention a set of speech parameters is determined for a particular user by means of a training session. For example, the user has to read a certain sample text, which serves to determine the speech parameters of the speaker's voice and/or speech. These parameters are stored in the communication device. When a communication link is established—such as a telephone call—the user's speech parameters are directly available at the start of the conversation and are transmitted to initialise the speech synthesizer and the receiver's side. Alternatively an initial speaker independent set of speech parameters is stored at the receiver's side for usage at the start of the conversation when the user specific set of speech parameters has not yet been transmitted.

In accordance with a further preferred embodiment of the invention the set of speech parameters being descriptive of the user's voice and/or speech are utilized at the receiver's side for identification of the caller. This is done by storing sets of speech parameters for a variety of known individuals at the receiver's side. When a call is received the set of speech parameters of the caller is compared to the speech parameter database in order to identify a best match. If such a best matching set of speech parameters can be found the corresponding individual is thereby identified. In one embodiment the individual's name is outputted from the speech parameter database and displayed on the receiver's display.

It is a further particular advantage of the invention that no additional noise reduction and/or echo cancellation is needed. This is due to the fact that the natural speech is recognized before data words being representative of the recognized natural speech are transmitted. Those data words only contain symbolic information with no or little redundancy. This way—as a matter of principle—noise and/or echo are eliminated.

In accordance with a further aspect of the invention the recognition of the natural speech is utilized to automatically generate textual messages, such as SMS messages, by natural speech input. This prevents typing text messages into the tiny keyboard of a portable communication device.

In accordance with a further aspect of the invention the communication device is utilized for dictation purposes. When the user dictates a letter or a message one or more sets of speech parameters and data words being descriptive of the recognized natural speech are transmitted over a network, such as a mobile telephony network and/or the internet, to a computer system. The computer system creates a text file based on the received data words containing the symbolic information and it also creates a speech file by means of a speech synthesizer. A secretary can review the text file and bring it into the required format while at the some time playing back the speech file in order to check the text file for correctness.

### BRIEF DESCRIPTION OF THE DRAWINGS

In the following preferred embodiments of the invention are described in greater detail by making reference to the drawing in which:

FIG. 1: shows a block diagram of a first embodiment of a communication device in accordance with the invention,

FIG. 2: shows an embodiment of a caller identification module based-on speech parameters,

FIG. 3: shows a block diagram of a dictation system in accordance with the invention,

FIG. 4: is illustrative of an embodiment of the methods of the invention.

### DESCRIPTION

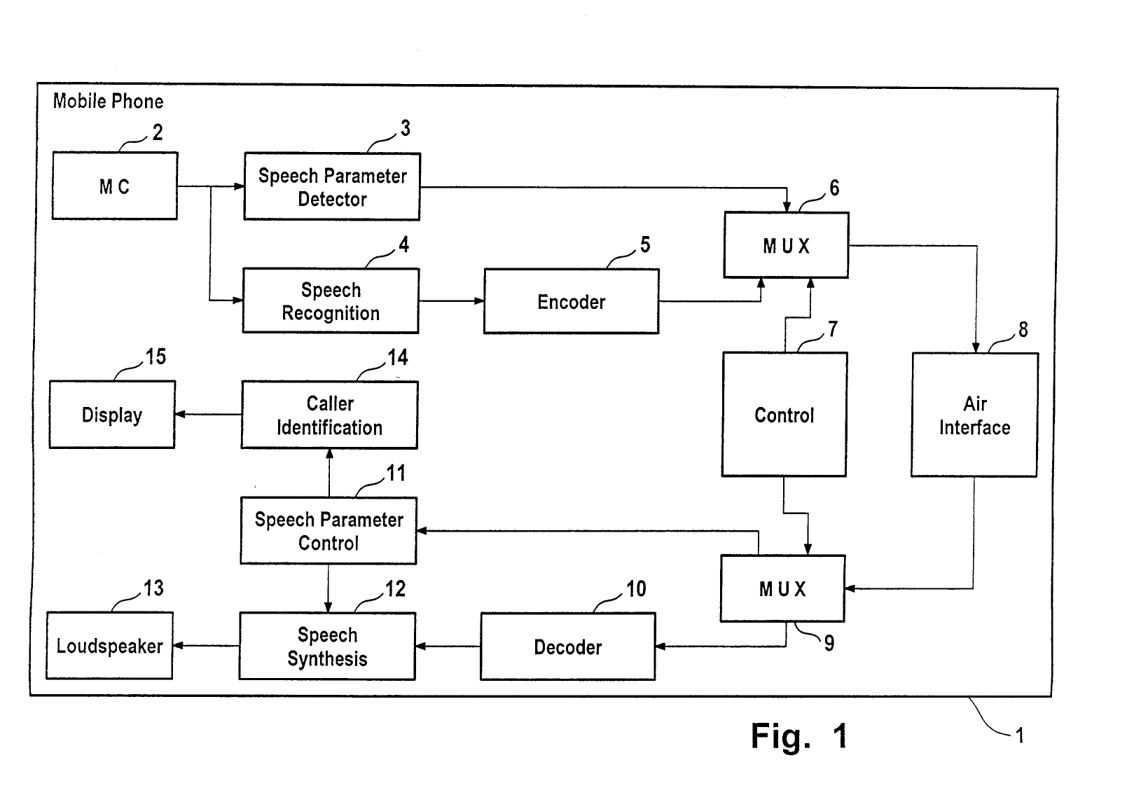

FIG. 1 shows a block diagram of a mobile phone 1. The mobile phone 1 has a microphone 2 for capturing the natural speech of a user of the mobile phone 1. The output signal of the microphone 2 is digitally sampled and inputted into speech parameter detector 3 and into speech recognition module 4. The microphone 2 can be a simple microphone or a microphone arrangement comprising a microphone, an analogue to digital converter and a noise reduction module.

The speech parameter decoder 3 serves to determine a set of speech parameters of a speech synthesis model in order to describe the characteristics of the user's voice and/or speech. This can be done by means of a training session outside a communication or it can be done at the beginning of a telephone call and/or continuously at certain time intervals during the telephone call.

The speech recognition module 4 recognises the natural speech and outputs a signal being descriptive of the contents of the natural speech to encoder 5. The encoder 5 produces at its output text and/or character and/or character string data. This data can be code compressed in the encoder 5 such as by Huffman coding or other data compression techniques.

The outputs of the speech parameter detector 3 and the encoder 5 are connected to the multiplexer 6. The multiplexer 6 is controlled by the control module 7. The output of the multiplexer 6 is connected to the air interface 8 of the mobile phone 1 containing the channel coding and high frequency and antenna units.

In order to transmit the natural speech of the user of the mobile phone 1 the control module 7 controls the control input of the multiplexer 6 such that the set of speech parameters of speech parameter detector 3 and the data words outputted by encoder 5 are transmitted over the air interface 8 during certain time slots of the physical link to the receiver's side.

Presuming that the receiver has a mobile phone with a similar construction as the mobile phone 1 the reception path within mobile phone 1 is equivalent:

The reception path within mobile phone 1 comprises a multiplexer 9 which has a control input coupled to the control module 7. The outputs of the multiplexer 9 are coupled to the decoder 10 and to the speech parameter control module 11.

The output of decoder 10 is coupled to the speech synthesis module 12. The speech synthesis module 12 serves to render natural speech based on decoded data words received from decoder 10 and based on the set of speech parameters from the speech parameter control module 11. The synthesized speech is outputted from the speech synthesis module 12 by means of the loudspeaker 13.

In operation a physical link is established by means of the air interface to another mobile phone of the type of mobile phone 1. During the telephone call one or more sets of speech parameters and encoded data words are received in time slots over the physical link. These data are demultiplexed by the multiplexer 9 which is controlled by the control module 7. This way the speech parameter control module 11 receives the set of speech parameters and the decoder 10 receives the data words carrying the recognized natural speech information. It is to be noted that the control module 7 is redundant and can be left away in case certain standardized transmission protocols are utilized.

The set of speech parameters is provided from the speech parameter control 11 to the speech synthesis module 12 and the decoded data-words are provided from the decoder 10 to the speech synthesis module 12.

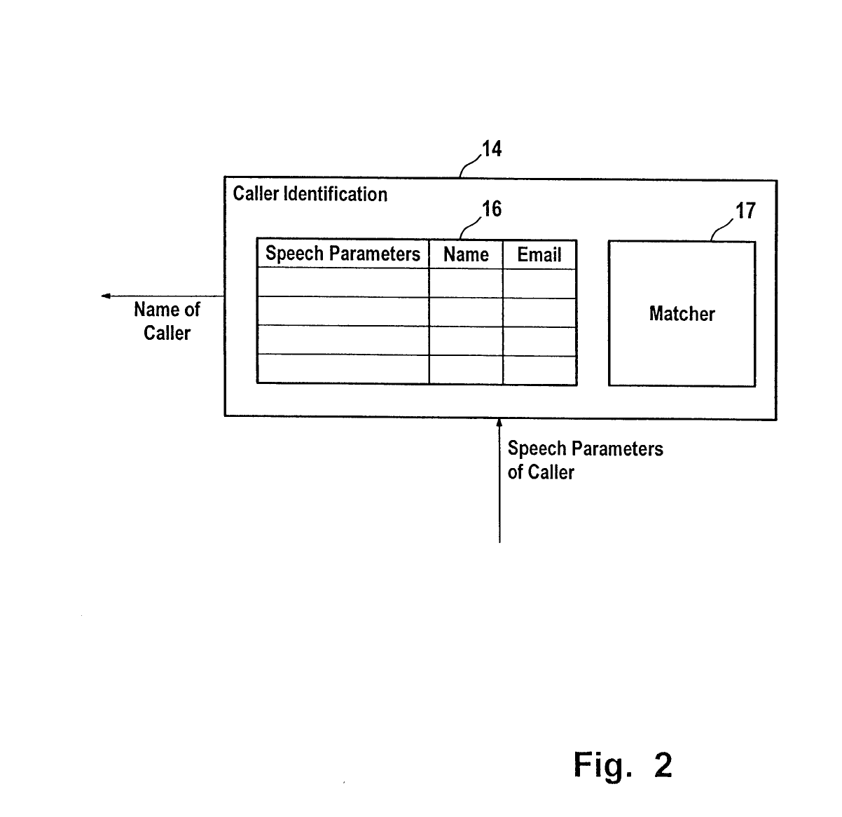

Further the mobile phone optionally has a caller identification module 14 which is coupled to display 15 of the mobile phone 1. The caller identification module 14 receives the set of speech parameters from the speech parameter control 11. Based on the set of speech parameters the caller identification module 14 identifies a calling party. This is described in more detail in the following by making reference to FIG. 2:

The caller identification module 14 comprises a data base 16 and a matcher 17.

The database 16 serves to store a list of speech parameter sets of a variety of individuals. Each entry of a speech parameter set in the database 16 is associated with additional information, such as the name of the individual to which the parameter set belongs, the e-mail address of the individual and/or further information like postal address, birthday etc.

When the caller identification module 14 receives a set of speech parameters of a caller from the speech parameter control module 11 (cf. FIG. 1) the set of speech parameters is compared to the speech parameter sets stored in the data base 16 by the matcher 17.

The matcher 17 searches the database 16 for a speech parameter set which best matches the set of speech parameters received from the caller.

When a best matching speech parameter set can be identified in the data base 16 the name and/or other information of the corresponding individual is outputted from the respective fields of the database 16. A corresponding signal is generated by the caller identification module 14 which is outputted to the display (cf. display 15 of FIG. 1) for display of the name of the caller and/or other information.

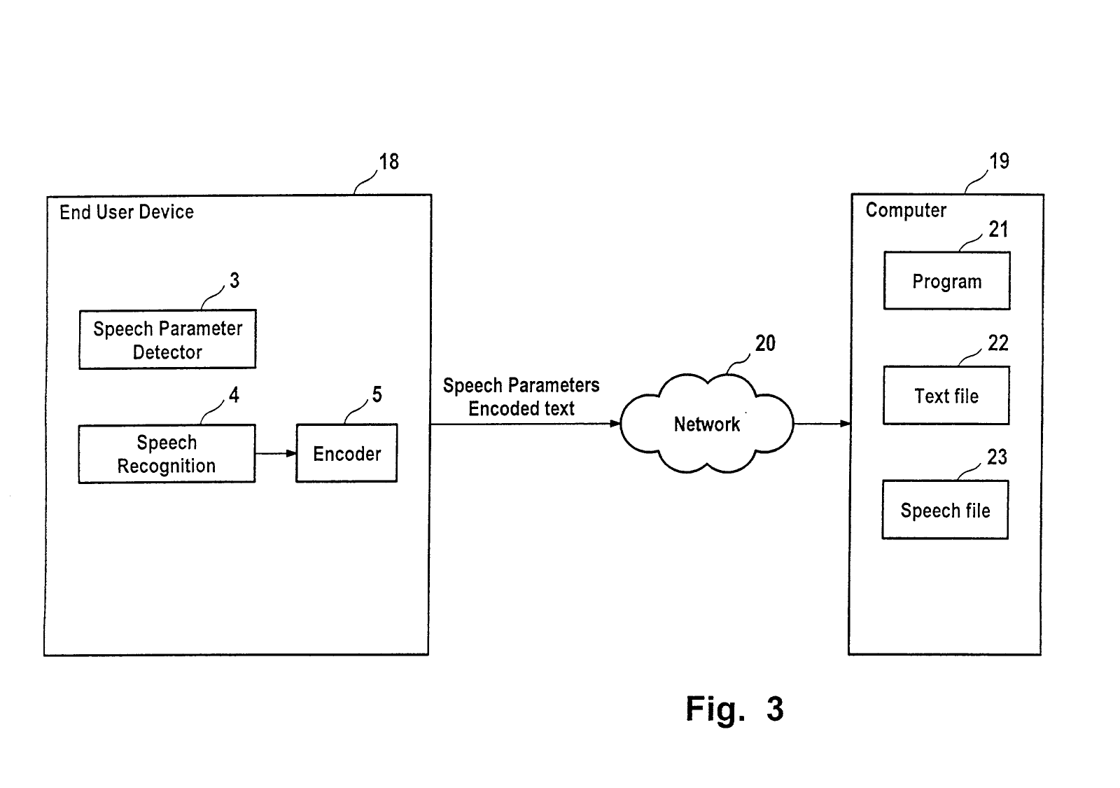

FIG. 3 shows a block diagram of a system for application of the present invention for a dictation service. Elements of the embodiment of FIG. 3 which correspond to elements of the embodiment of FIG. 1 are designated by the same-reference numerals.

The end user devices 18 of the system of FIG. 3 corresponds to mobile phone 1 of FIG. 1. In addition to the functionality of the mobile phone 1 of FIG. 1 the end user devices 18 of FIG. 3 can incorporate a personal digital assistant, a web pad and/or other functionalities. A communication link can be established between the end user device 18 and computer 9 via the network 20, e.g. a mobil telephony network or the Internet.

The computer 19 has a program 21 for creating a text file 22 and/or a speech file 23.

For the dictation service the end user can first establish a communication link between the end user device 14 and the computer 19 via the network 20 by dialing the telephone number of the computer 19. Next the user can start dictating such that one or more sets of speech parameters and encoded data words are transmitted as explained in detail with respect to the embodiments of FIG. 1. Alternatively the end user utilizes the end user device 18 in an off-line mode. In the off-line mode a file is generated in the end user device 18 capturing the sets of speech parameters and the encoded data words. After having finished the dictation the communication link is established and the file is transmitted to the computer 19.

In either case the program 21 is started automatically when a communication link with the end user device 18 is established. The program 21 creates a text file 22 based on the encoded data words and it creates a speech file 23 by synthesizing the speech by means of the set of speech parameters and the decoded data words. For example the program 21 has a decoder module for decoding the encoded data words received vie the communication link from the end user device 18.

A user of the computer 19, such as a secretary, can open the text file 22 to review it or for other purposes such as printing and/or archiving. In addition or alternatively the secretary can also start playback of the speech file 23.

In an alternative application an interface such as Bluetooth, USB and/or an infrared interface is utilized instead of the network 20 to establish a communication link. In this application the user can employ the end user device 18 as a dictation machine while he or she is away from his or her's office. When the user comes back to the office he or she can transfer the file which has been created in the off-line mode to the computer 19.

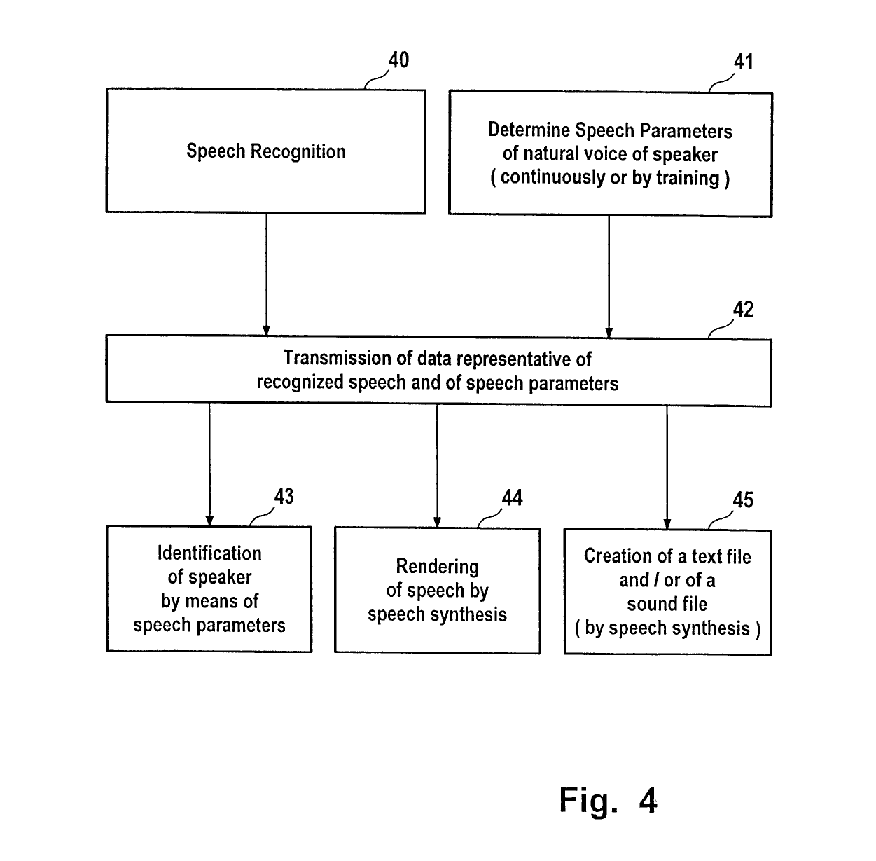

FIG. 4 shows a corresponding flow chart. In step 40 natural speech is recognized by any known speech recognition method. The recognized speech is converted into symbolic data, such as text, characters and/or character strings.

In step 41 a set of speech parameters of a speech synthesis model being descriptive of the natural voice and/or the speech characteristics of a speaker is determined. This can be done continuously or at certain time intervals. Alternatively the set of speech parameters can be determined by a training session before the communication starts.

In step 42 the data being representative of the recognized speech, i.e. the symbolic data, and the speech parameters are transmitted to a receiver.

At the receiver's side one or more of the following actions can be performed:

In step 43 the speaker is recognized based on his' or her's speech parameters. This is done by finding a best matching speech parameter set of previously stored speaker information (cf. caller identification module 14 of FIG. 2).

Alternatively or in addition in step 44 the speech is rendered by means of speech synthesis which evaluates the speech parameters and the data words. It is a particular advantage that the speech can be synthesized at a high quality with no noise or echo components.

Alternatively or in addition in step 45 a text file and/or a sound file is created. The text file is created from the data words and the sound file is created by means of speech synthesis (cf. the embodiments of FIG. 3).

1. A communication device comprising:
means for determining at least one speech parameter of a speech synthesis model,
means for recognizing natural speech,
means for transmitting the at least one speech parameter and data representative of the recognized speech.

2. The communication device of claim 1 the means for determining the at least one speech parameter being adapted to determine the parameters of a code-exited linear predictive speech coding model.

3. The communication device of claim 1 further comprising means for encoding the recognized natural speech by means of symbolic data, such as text, character strings and/or characters.

4. A communication device comprising:
means for receiving of at least one speech parameter of a speech synthesis model and for receiving data being representative of recognized natural speech,
means for generating a speech signal based on the at least one speech parameter and based on the data being representative of the recognized speech.

5. The communication device of claim 4 further comprising caller identification means for identification of a caller based on the received at least one speech parameter of the caller, the caller identification means preferably comprising database means for storing speech parameters and associated caller identification information, such as the caller's name, telephone number and/or e-mail address, and matcher means for searching the database means for a best matching speech parameter.

6. A computer system comprising:
means for receiving of at least one speech parameter of a speech synthesis model and for receiving data being representative of recognized natural speech,
means for creating a text file from the data being representative of the recognized speech; and
means for creating a speech file by means of the speech synthesis model and the received at least one speech parameter and the data being representative of the recognized natural speech.

7. A method for transmitting of natural speech comprising the steps of:
determining at least one speech parameter of a speech synthesis model,
recognizing the natural speech,
transmitting the at least one speech parameter and the data being representative of the recognized speech.

8. The method of claim 7 further comprising continuously determining the at least one speech parameter and/or determining the at least one speech parameter before the transmission by means of a user training session and/or using an initial value for the at least one speech parameter.

9. A method for receiving of natural speech comprising the steps of:
receiving of at least one speech parameter of a speech synthesis model and receiving data being representative of recognized speech,
means for generating a speech signal based on the at least one speech parameter and based on the data being representative of the recognized speech.

10. A computer program product for performing a method in accordance with claim 7.

11. A computer program product for performing a method in accordance with claim 8.

12. A computer program product for performing a method in accordance with claim 9.
